(19) United States
(12) Patent Application Publication
(10) Pub. No.: US 2008/0176448 A1
(43) Pub. Date: Jul. 24, 2008

(54) Plug-in connector

(75) Inventors: Hartmut Muller, Braunlingen (DE); Roland Dold, Furtwangen (DE)

Correspondence Address: NATH & ASSOCIATES, 112 South West Street, Alexandria, VA, 22314, US

(73) Assignee: MC TECHNOLOGY GmbH, Blumberg (DE)

(21) Appl. No.: 12/007,313

(22) Filed: Jan. 9, 2008

(30) Foreign Application Priority Data
Jan. 15, 2007 (DE) 20 2007 000 848.1

(51) Int. Cl. H01R 13/648

(52) U.S. Cl. 439/607

(57) ABSTRACT

The invention refers to a plug-in connector for multi-core data and/or telecommunication cables having a shielding housing joined together from an upper housing shell and a lower housing shell, wherein a contract carrier, which demonstrates connector contacts for the plug-in connection and insulation displacement contacts electrically connected to these connector contacts, for the cores of the cable, is disposed in the lower housing shell, and wherein a loading element, which demonstrates receptacles for the cores of the cable, is disposed in the upper housing shell, wherein the insulation displacement contacts of the contact carrier penetrate the cores when the housing shells are joined together, wherein a potential balancing contact is disposed on the upper housing shell.

The invention relates to a plug-in connector pursuant to the preamble of claim 1.

Plug-in connectors for multi-core data and/or telecommunications cables that demonstrate a shielding housing are known. To this end, known housings are joined together from an upper housing shell and a lower housing shell, wherein a contact carrier, which demonstrates connector contacts for the plug-in connection and insulation displacement contacts electrically connected to these connector contacts for the cores of the cable, is disposed in the lower housing shell. A loading element, which demonstrates receptacles for the cores of the cable, is disposed in the upper housing shell, whereby the insulation displacement contacts of the contact carrier penetrate the cores when the housing shells are joined together. This establishes the electrically conductive contact between the cores of the cable and the connector contacts for the plug-in connector. This type of plug-in connector can be derived from DE 100 57 833 A1, for example.

Depending on the application, an insulated installation of the plug-in connector into various components is required. In this respect, it is known to selectively connect the lower housing shell to a balancing potential. This connection is produced by way of plug-in connectors, screwed contacts or spring contacts, for example. When exchanging the lower housing shell, it is then necessary, however, to also detach the potential balancing contact and reconnect it to the new lower housing shell. But this represents an additional effort for the user and a potential source of error, because it is possible to forget to close the potential balancing contact again.

The object of the invention is therefore to make available a plug-in contact for multi-core data and/or telecommunications cables that is easier to handle.

The object is achieved by means of a plug-in connector having the characteristics of claim 1.

Advantageous embodiments and further developments of the invention are indicated in the dependent claims. In the plug-in connector according to the invention, a potential balancing contact is disposed in the upper housing shell. No separation of the potential balancing contact is therefore necessary when exchanging the lower housing shell of the plug-in connector. The potential balancing contact remains connected to the upper housing shell so that, for one thing, the extra step of separating and reconnecting the potential balancing contact is superfluous, and it is not possible to forget the reconnection during assembly.

In an advantageous further development of the invention, the potential balancing contact is configured as a plug-in contact, so that it is particularly easy to connect and detach again, if necessary. To this end, it is particularly preferred to configure the potential balancing contact as a flat plug-in contact that can slide on a contact reed, because this potential balancing contact is particularly inexpensive to manufacture and easy to install.

In a particularly advantageous embodiment of the invention, the potential balancing contact is disposed on the upper housing shell in such a manner that a connecting lead connected to the potential balancing contact can be routed parallel to the cable. This provides the user a better overview of the feed lines to the plug-in connector.

The potential balancing contact is preferably disposed in the loading element in spatial proximity to the inlet opening of the cable, so that it is also possible to route the connecting lead in spatial proximity to the cable.

The housing shells are preferably designed as metallic die castings, so that the potential balance between the two housing shells can be established by means of the connecting contacts of the two housing shells, which can be designed as a locking mechanism, for example.

The invention will be explained in detail below on the basis of the following figures. The drawing shows

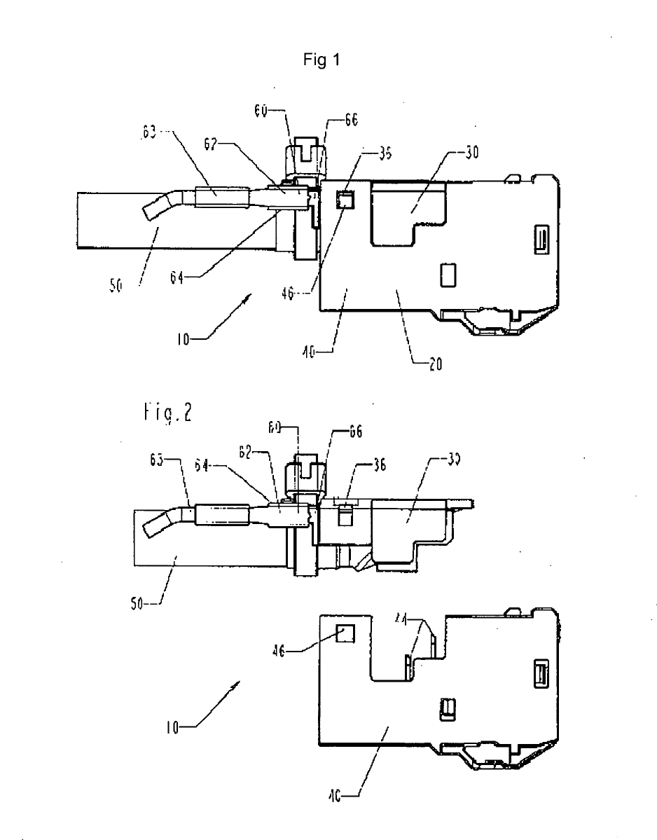

FIG. 1 a side representation of an exemplary embodiment of a plug-in connector according to the invention,

FIG. 2 the plug-in connector as per FIG. 1 with disassembled housing,

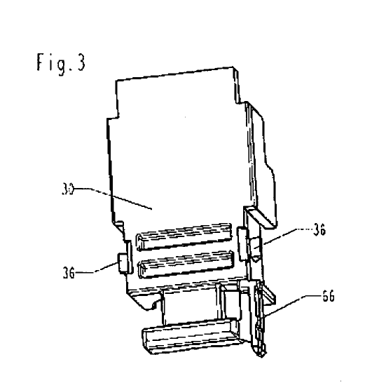

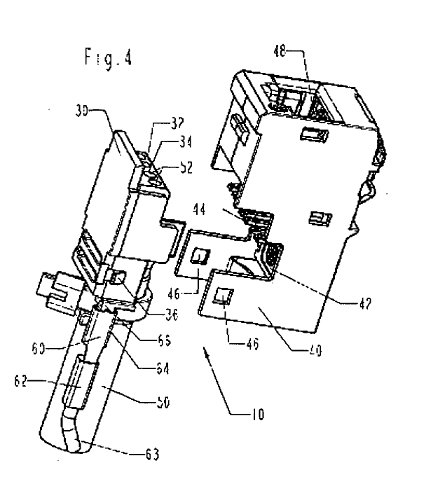

FIG. 3 a perspective view of the upper housing shell of the plug-in connector as per FIG. 1, and

FIG. 4 a perspective representation of the plug-in connector as per FIG. 1 in the disassembled state.

FIGS. 1 to 4 show various views of a plug-in connector 10 having a housing 20, which is composed of an upper housing 30 and a lower housing shell 40.

The plug-in connector 10 serves for connecting a cable 50 having a plurality of cores 52, especially of a multi-core data and/or telecommunications cable. To this end, the cable 50 is preferably shielded, for which purpose it is surrounded, in particular, by a conductive braided shield.

The upper housing shell 30 and the lower housing shell 40 are preferably produced from an electrically conductive material and, in particular, as a metallic die casting, for example a zinc die casting. The two housing shells 30, 40 are joined together by way of a locking mechanism, whereby two locking projections 36, which engage into corresponding receiving elements 46 on the lower housing shell 40, are disposed on the upper housing shell 30.

A loading element 32, which demonstrates receptacles 34 for receiving the cores 52 of the cable 50, is disposed in the upper housing shell 30. The cable 50 is thus fed into the upper housing shell 30 and the loading element 32 through an inlet opening, the sheathing of the cable 50 being removed inside the upper housing shell, so that the separate cores 52 can be laid into the receptacles 34 of the loading element 32 and be fixed in place there.

A contact carrier 42, which demonstrates insulation displacement contacts 44, is disposed in the lower housing shell 40, the number of insulation displacement contacts 44 preferably corresponding to the number of cores 52 of the cable 50. Connector contacts connect the insulation displacement contacts 44 to an inlet opening 48 of the lower housing shell 40, so that a corresponding plug can be inserted into the inlet opening 48 to establish contact between the connector contacts and the insulation displacement contacts 44. To this end, the insulation displacement contacts 44 are disposed on the contact carrier 42 in such a manner that, when the upper housing shell 30 with the loading element 32 is placed onto the lower housing shell 40, the insulation displacement contacts 44 penetrate the cores 52 of the cable 50, said cores being disposed in the receptacles 34 of the loading element 32, and thereby establish electrical contact between the cable 50 and a plug inserted into the inlet opening 48.

Depending on the use of the plug-in connector 10, it is necessary for electrically conductive housings 20 to be disposed in insulated manner. To this end, however, the shielding of the plug-in connector 10 must be selectively connected to a balancing potential. To this end, a potential balancing contact 60, which is preferably designed as a flat plug-in contact 62 having a cable lug 64 that can be pushed over a contact reed 66 that is connected to the upper housing shell 30 in electrically conductive manner, is disposed on the upper housing shell 30. A corresponding connecting lead 63 for the potential balance terminates at the flat plug-in contact 62. The potential balance of the upper housing shell 30 can be accomplished via the flat plug-in contact 62, in simple manner. Since the upper housing shell 30 is connected to the lower housing shell 40 by way of a lock connection made of an electrically conductive material, the potential balance for the lower housing shell 40 thereby takes place in the same way. Because of the fact that the potential balancing contact 60 is disposed on the upper housing shell 30, it is no longer necessary to remove the potential balancing contact 60 when the lower housing shell 40 is exchanged, so that it will also not be possible to forget to reclose the potential balancing contact after exchanging the lower housing shell 40.

The contact reed 66 is preferable disposed on the upper housing shell 30 in such a manner that the connecting lead 63 can be routed to the upper housing shell 30 in the same direction as the cable 50. Alternatively, the contact reed 66 can also be disposed inside the upper housing shell 30 and, in particular, on the loading element 32. Due to the fact that the feed direction for the cable 50 and for the connecting lead 63 into the upper housing shell 30 are the same directions, it is possible to first route the cable 50 and the connecting lead 63 in parallel, also allowing the user a simple overview of the plug-in connector 10 and the corresponding feed lines. In particular, in this regard, the additional connecting lead 63 for the potential balance does not hinder access to the lower housing shell 40.

### LIST OF REFERENCE SYMBOLS

10 plug-in connector
20 housing
30 upper housing shell
32 loading element
34 receptacle
36 locking projection
40 lower housing shell
42 contact carrier
44 insulation displacement contact
46 receiving element
48 inlet opening
50 cable
52 core(s)
60 potential balancing contact
62 flat plug-in contact
63 connecting lead
64 cable lug
66 contact reed

1. Plug-in connector (10) for multi-core data and/or telecommunications cables (50) having a shielding housing (20) joined together from an upper housing shell (30) and a lower housing shell (40), wherein a contact carrier (42), which demonstrates connector contacts for the plug-in connection and insulation displacement contacts (44) electrically connected to these connector contacts, for the cores (52) of the cable (50), is disposed in the lower housing shell (40), and wherein a loading element (32), which demonstrates receptacles (34) for the cores (52) of the cable (50), is disposed in the upper housing shell (30), wherein the insulation displacement contacts (44) of the contact carrier (42) penetrate the cores (52) when the housing shells (30, 40) are joined together, characterized in that a potential balancing contact (60) is disposed on the upper housing shell (30).

2. Plug-in connector according to claim 1, characterized in that the potential balancing contact (60) is configured as a plug-in contact.

3. Plug-in connector according to one of the preceding claims, characterized in that the potential balancing contact (60) is configured as a flat plug-in contact (62) that can slide on a contact reed (66).

4. Plug-in connector according to one of the preceding claims, characterized in that the potential balancing contact (60) is disposed on the upper housing shell (30) in such a manner that a connecting lead (63) connected to the potential balancing contact (60) can be routed parallel to the cable (50).

5. Plug-in connector according to one of the preceding claims, characterized in that the potential balancing contact (60) is disposed in spatial proximity to the inlet opening of the cable (50) into the loading element (32).

6. Plug-in connector according to one of the preceding claims, characterized in that the housing shells (30, 40) are configured as metallic die castings.
